(19) United States
(12) Patent Application Publication
(10) Pub. No.: US 2009/0092523 A1
(43) Pub. Date: Apr. 9, 2009

(54) POLLUTANT DECOMPOSITION DEVICE

(75) Inventors: Claes-Goran GRANQVIST, Uppsala (SE); Stefan Bertilsson, Uppsala (SE)

Correspondence Address: YOUNG & THOMPSON, 209 Madison Street, Suite 500, ALEXANDRIA, VA, 22314, US

(73) Assignee: CHROMOGENICS SWEDEN AB, UPPSALA (SE)

(21) Appl. No.: 11/933,447

(22) Filed: Nov. 1, 2007

(30) Foreign Application Priority Data
Nov. 3, 2006 (SE) 0602329-5

(51) Int. Cl. B01J 32/00; B01J 37/02; B01D 53/88; B01J 16/00

(52) U.S. Cl. 422/122; 422/222; 264/134

(57) ABSTRACT

Pollutant decomposition device comprising a flexible sheet-substrate provided with at least one photocatalytic surface wherein the sheet-substrate comprises one or more internal slits with a layout that provides formation of flow restricting means upon predetermined deformation of the sheet substrate. There is also provided a method of producing a pollutant decomposition device.

### THE FIELD OF THE INVENTION

The present invention relates to a pollutant decomposition device, capable of decomposing a broad range of biological and chemical pollutants by photocatalytic reactions.

### BACKGROUND OF THE INVENTION

The use of photocatalytic pollutant decomposition device is an evolving approach to clean polluted medium, such as air or water. The basic principle is that a polluted medium is brought in contact with a photocatalytic surface, which is irradiated with light. Pollutants in proximity to the photocatalytic surface are then decomposed into harmless, odorless, and less toxic compounds. The process of photocatalysis is well known in the art, and no detailed description is given herein. One well-known photocatalyst is titanium dioxide (TiO₂), and other known photocatalysts are ZnO, CdS, WO₃, SnO₂, ZrO₂, Sb₂O₄, CeO₂ and Fe₂O₃. In general, the resulting photocatalytic activity of these materials is higher when the applied irradiation is of high energy (short wavelength), such as light in the ultraviolet spectrum. WO 96/37291, U.S. Pat. No. 5,045,288 and U.S. Pat. No. 4,892,712 all show air cleaners based on photocatalysts, whereas JP2005313088 JP2002052386, JP11000657, and JP6285458 all show water purifiers.

### SUMMARY OF THE INVENTION

The object of the invention is to provide a new pollutant decomposition device, flow through medium cleaner, and methods which overcome the drawbacks of the prior art. This is achieved by the device as defined in the independent claims.

Some advantages with the pollutant decomposition device according to the invention are:
It is extremely simple to manufacture, and is solely based on low cost materials, whereby it can be produced in large volumes at very low cost.
In compact state, prior to deformation into its working state, space requirements during transport and storage are minimal, whereby large quantities can be transported and distributed in a simple manner.
As the device is based on catalytic activity, the device itself is not subjected to any wear due to the decomposition process.
Spacers reduce the contact area between the photocatalytic surface and a container in which it is situated, whereby mechanical wear of the photocatalytic surface effectively is prevented. Hence the expected life-span for the device is essentially unlimited.
The robustness and simplicity of the device are exceptional, as it does not involve any moving parts or does not require any additional power (except for light, preferably sunlight) to function.
The device is able to eliminate all biological and most chemical (e.g. organic) pollutants in one simple step, whereby it does not put any special requirements on the user, and thus allows anyone to benefit from the device.

Other advantages are apparent from the following detailed description of the present invention.

Embodiments of the invention are defined in the dependent claims.

### BRIEF DESCRIPTION OF THE DRAWINGS

The invention will be described in detail below with reference to the drawings, in which:

FIG. 1 shows examples of absorption spectra for photocatalytic TiO₂ of two different structures, anatase and rutile.

FIGS. 2a to 2d show four embodiments of pollutant decomposition devices according to the present invention.

FIG. 3 shows the pollutant decomposition device according to FIG. 2c in the deformed state.

FIG. 4 shows an alternative embodiment of the pollutant decomposition device according to the present invention.

### DETAILED DESCRIPTION OF PREFERRED EMBODIMENTS

The pollutant decomposition device according to the present invention generally relates to a solar radiation-activated photocatalytic pollutant decomposition device, i.e. the device comprises a photocatalytic surface that is in contact with the medium to be purified, and the irradiation that give rise to the photocatalytic activity is mainly provided by the sun. However, during night time or at locations where sunlight is not present in sufficient amounts, the pollutant decomposition device may be operated with alternative radiation sources such as lamps emitting light of suitable wavelengths.

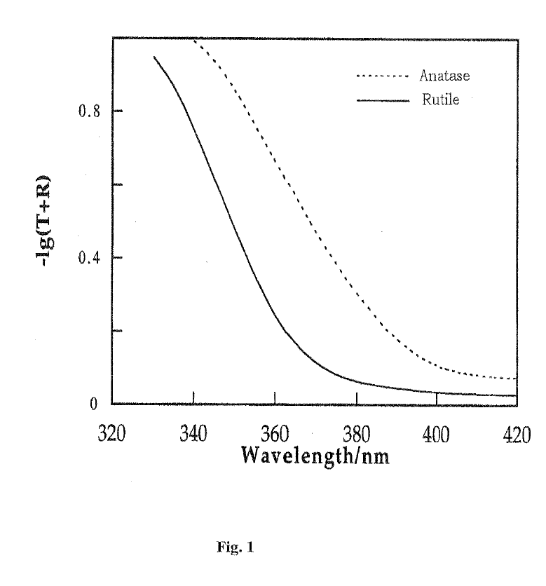

As mentioned above, maximum photocatalytic activity of the preferred photocatalysts is generally obtained when the photocatalyst is irradiated with light in the ultraviolet spectrum, i.e. light of wavelengths less than approximately 380 nm. FIG. 1 shows examples of absorption spectra for photocatalytic TiO₂ of two different structures, anatase and rutile. As can be seen in FIG. 1, the lower absorption limit is about 370 nm for anatase and 400 nm for rutile. Therefore, it is of great importance that the solar irradiation that reaches the photocatalytic surface in a pollutant decomposition device comprises as much ultraviolet irradiation as possible, to achieve optimum efficiency for the decomposition process. Hence, it is important to select a material with low ultraviolet absorption for any transparent parts of the pollutant decomposition device or a purification system comprising the pollutant decomposition device. Solar irradiation reaching the surface of the earth contains ultraviolet radiation in the UV-A (320-400 nm) to UV-B (280-320 nm) wavelength range and can therefore, as discussed above, be used as the irradiation source for the photocatalytic pollutant decomposition device according to the present invention.

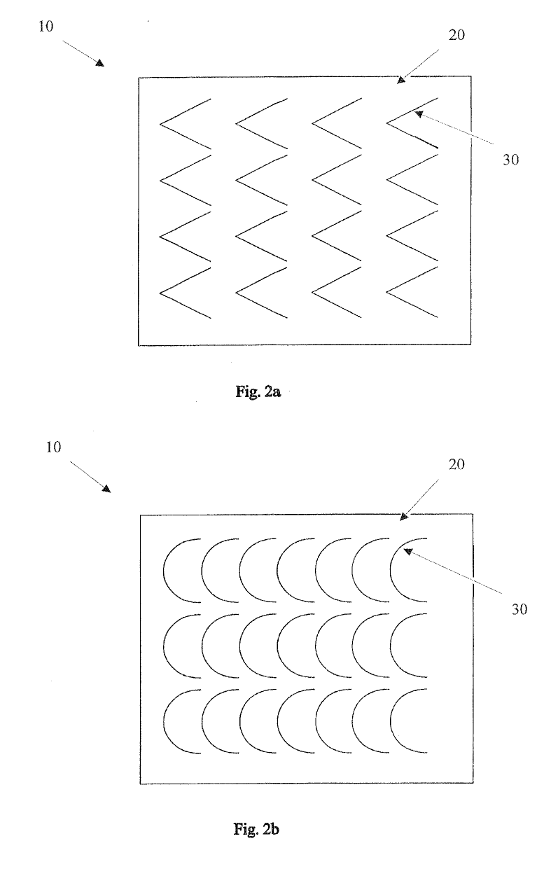

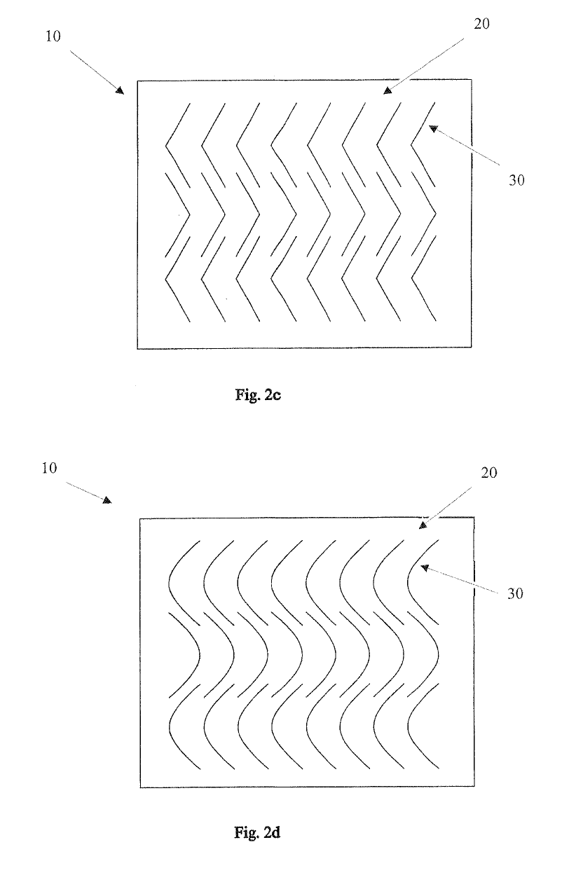

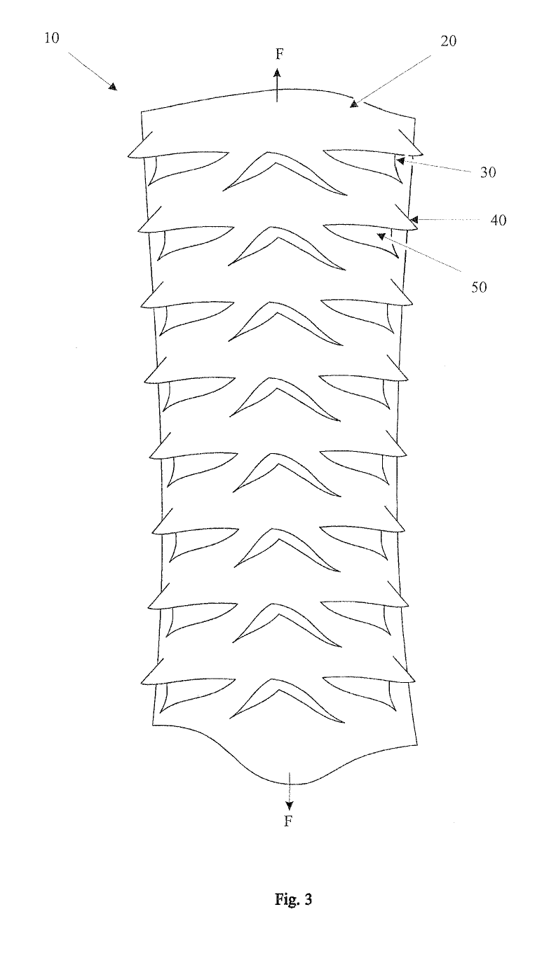

The pollutant decomposition device 10 according to one embodiment of the present invention, as is schematically disclosed in FIGS. 2a to 4 comprises a flexible sheet-substrate 20 provided with at least one photocatalytic surface, wherein the sheet-substrate 20 comprises one or more internal slits 30 with a layout that provides formation of flow restricting means 40 upon predetermined deformation of the sheet substrate.

In order to achieve efficient decomposition of pollutants in a medium, by means of a surface active decomposition device of this type, it is of great importance that the medium in contact with the surface continuously is renewed. In a static situation with essentially no movement in the medium, the transport of pollutants to the surface of the device will be by diffusion and migration, which in the long term is much slower than in a medium in motion. Such motion may be achieved by creating a flow in the medium, by agitation, or by thermal convection etc. Therefore, the pollutant decomposition device is mainly intended to provide decomposition of pollutants in a medium in motion. However, in situations with a more or less constant motion of medium, flow along a surface gives rise to a laminar behavior, wherein the medium in contact with the surface is more or less static, and the transport of pollutants to the surface is impaired. In order to avoid the negative effect of laminar flow the pollutant decomposition device comprises flow restricting means that restrict the flow about the surface of the device and create a non-laminar flow about the active surface of the device. The flow restricting means may be of virtually any shape, as long as they prevent the occurrence of laminar flow, such as fins, flaps, protruding tongues, ridges, curved surfaces, etc.

The sheet substrate may be of any suitable flexible sheet material that is stable in the medium to be depolluted, and that is not excessively decomposed by a photocatalytic coating thereon during the purification process. A suitable flexible sheet substrate may e.g. be a film, foil, fabric, non woven fabric, mesh etc, of any suitable material, such as a polymer, metal, glass, carbon, organic fibres etc. The sheet substrate may further at least in part be comprised of a photocatalytic material. Depending on the intended use of the pollutant decomposition device, there are different requirements on the mechanical properties of the sheet substrate.

Deposition of a photocatalytic layer on a flexible sheet substrate can be made by a number of methods well known in the art of photocatalysts and is therefore not discussed in more detail herein. Several of the conventional methods can be used to produce large quantities of deposited substrates at low cost and are therefore well suited for mass production. The photocatalytic layer may cover the entire surface or sections thereof on either or both sides of the sheet.

Slitting of the sheet substrate can be made by a number of conventional techniques widely used in the paper, plastic film industry etc

FIGS. 2a to 2d show four examples of internal slit layouts, all arranged to provide flow restricting means in the form of protruding tongues after deformation of the sheet substrate. In the layouts shown in FIGS. 2a and 2b the slits 30 are provided as parallel rows of V and U shaped slits 30 respectively, forming flow restricting means 40 in the form of V or U shaped tongues or fins after proper deformation of the sheet. The layouts shown in FIGS. 2c and 2d differ from the layouts in FIGS. 2a and 2b in that adjacent rows of slits are offset by the half center to center distance between two slits, and arranged upside-down. In addition to internal slits, the sheet substrate may also comprise edge slits and perforations of various forms. The layout of the internal slit/s may be selected to provide a wide range of flow restricting means, that all serve to create a non laminar flow along the pollutant decomposition device.

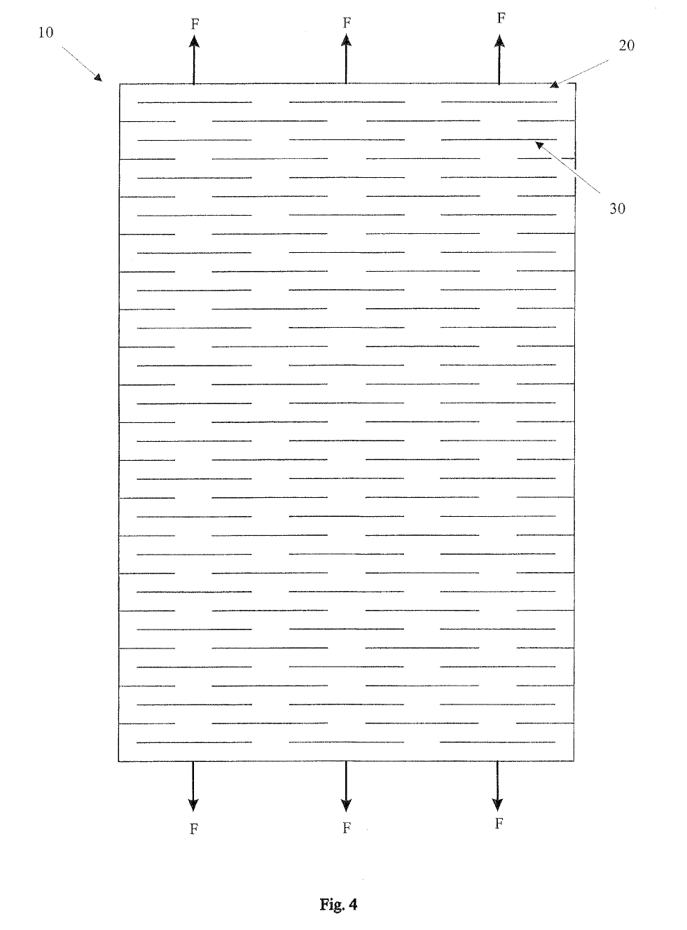

In order to transform the slitted sheet substrate to a pollutant decomposition device with flow restricting means that prevent laminar flow at the active surface of the device, the sheet substrate is deformed in a predetermined fashion such that the desired flow restricting means 40 are formed. The predetermined deformation of the sheet substrate comprises folding, stretching, coiling or twisting, or a combination thereof. FIG. 3 shows one schematic embodiment of a pollutant decomposition device, wherein a sheet substrate with a slit layout shown in FIG. 2c is deformed by application of a stretch-force F as indicated by the arrows in FIG. 3. In FIG. 3 the slit layout provides a plurality of flow restriction means 40 in the form of tongues and an over all curving of the sheet. Moreover, as can be seen in FIG. 3, the slits forming the flow restriction means provide passages 50 between opposite sides of the sheet substrate, which further reduces laminar flow. In some embodiments, the flow restriction means have the form of a flap or tongue that actively redirects a section of the flow of a medium through a slit passage. FIG. 4 shows another example of a slit layout wherein the slits 30 are straight, and arranged in shifted rows. When applying a stretch force F as indicated in the figure, the deformation of the sheet substrate 20 will result in a shape that conforms to expanded metal.

According to one embodiment, the predetermined deformation of the sheet substrate comprises folding, stretching, coiling or twisting, or a combination thereof. The deformation of the sheet substrate may be essentially elastic, but it may also be at least partially plastic. Hence different combinations of slit layouts and deformations can be used depending on the types of flow restricting means that are desired.

In some applications it is desirable that the flow restricting means are formed to provide a small contact area between the pollutant decomposition device and an adjacent surface. In other applications, the pollutant decomposition device comprises at least one interlock member arranged to fit into a mating interlock slit in order to interlock the deformed sheet substrate in the deformed state. In still other applications, the pollutant decomposition device is retained in the deformed state by external means applying the desired force(s) on the sheet substrate.

The disclosed pollutant decomposition device may be used to decompose pollutants in any application wherein a medium is passed by the same. The device may be used in a flow through medium cleaner wherein it is arranged in a flow channel thereof, in order to clean the medium passed through the channel. According to one embodiment, the pollutant decomposition device may be arranged in a confined space to be cleaned, such as a room, and the medium within the space is made to pass the device by means of thermal convection or the like.

There is also provided a flow through medium cleaner comprising at least one flow channel, and at least one pollutant decomposition device according to the present invention arranged in the flow channel. The flow through medium cleaner may for instance be an intake air cleaner for a fresh air distribution system in a building, or be incorporated as an air cleaner in an air recirculation system. In an alternative embodiment, the medium to be cleaned is water at a water station, wherein at least one pollutant decomposition device is arranged in a water stream to decompose undesirable compounds contained therein.

There is also provided a method of producing a pollutant decomposition device, comprising the steps:

providing a flexible sheet substrate,
depositing a photocatalytic layer on a surface of the sheet substrate,
slitting the sheet substrate to form one or more internal slits with a layout that provides formation of flow restricting means upon predetermined deformation of the sheet substrate, and
deforming the sheet substrate in a predetermined manner.

One advantage with the disclosed pollutant decomposition device is that it can be produced in large volume at a low cost. The production may be performed by means of a continuous process, wherein the sheet substrate is provided as a coil, and wherein the photocatalytic layer is deposited by a continuous deposition process. The slitting is preferably performed in the same continuous process without stopping the feeding of the sheet substrate. The deformation of the sheet substrate may then be performed as a continuous step following the slitting. Then, the finished pollutant decomposition devices are cut into pieces of desired length. Alternatively, before deformation, the slitted sheet substrate may be rolled on a coil or cut into sheets of desired dimensions and stored or transported in this flat state in order to reduce the volume. As all of the above techniques for producing the disclosed pollutant decomposition device are well known to any one skilled in the art, they are not described further herein.

The pollutant decomposition device according to one embodiment of the present invention, comprises spacer means arranged to reduce the contact area between the pollutant decomposition device and an adjacent surface. Due to the spacer means, the device can be arranged adjacent to a transparent wall, e.g. in a container, while preserving an essentially free flow of medium between the wall and the pollutant decomposition device. Moreover, this design makes it possible to provide very simple and effective flow through medium cleaning devices, as will be shown in detail below.

### Detailed Description of an Example of a Water Purifying Device

One embodiment of the pollutant decomposition device is comprised of a coiled flexible sheet, and the spacer means are comprised of a plurality of tongues that protrude from the coiled flexible sheet, each tongue being formed by a slit in the flexible sheet. The device may comprise two or more rows of tongues, and the tongues may be of any suitable shape. Moreover the device can comprise at least one interlock tongue arranged to fit into a mating interlock slit in order to interlock the coiled flexible sheet in a coiled state. The interlocked coiled state is especially suitable in cases when the pollutant decomposition device is arranged inside a transparent essentially cylindrical container. In order to fit the device inside a container with a narrow opening, e.g. a bottle, the device is first rolled (coiled in a tight manner, so that it fits into the opening. Thereafter, when the device has entered the wider compartment in the bottle, the flexible properties of the sheet strives to uncoil the device, the uncoiling is however terminated by the contact between the spacer means and the inner wall of the bottle, or alternatively by an interlocking tongue arrangement.

According to one embodiment of the pollutant decomposition device according to the present invention, the device is expandable from a compact state to an expanded state. The expansion of the decomposition device may either be actuated by an external force through an actuation arrangement or by stored force in the compacted device, i.e. self-expanding. As is the case in the previous embodiments, the device may be based on a flexible sheet substrate, that is folded and/or rolled in a tight manner to form the compact state.

In more general terms the compact state permits insertion of the device through an opening in a transparent container, the opening having a cross sectional area that is smaller that the cross sectional area of a cavity inside the container with respect to the direction of insertion, and the expanded state retains the device inside the container.

According to one embodiment the device is retained in the compacted state by a soluble and/or decomposable adhesive. In this embodiment, the device is ready to be fitted into a container, and the expansion is triggered when it is immersed in water or when the photocatalytic process is activated.

As is evident from above, the device is of extremely simple design and hence extremely simple to produce. The disclosed embodiments have triangular or rounded tongues. The production comprises the steps:

providing a flexible sheet substrate,
depositing a photocatalytic layer on a surface of the sheet substrate, and
slitting the sheet substrate to form a plurality of tongues that protrude from the flexible sheet when coiled.

The flexible substrate may be any thin flexible sheet material that is stable in water, and that is not excessively decomposed by a photocatalytic coating thereon during the purification process. A suitable flexible sheet substrate may e.g. be a film, foil, fabric, non woven fabric, mesh etc, of any suitable material, such as a polymer, metal, glass, carbon, etc.

Deposition of a photocatalytic layer on a flexible sheet substrate can be made by a number of methods well known in the art of photocatalysts and is therefore not discussed in more detail herein. Several of the conventional methods can be used to produce large quantities of deposited substrates at low cost and are therefore well suited for mass production.

Slitting of the sheet substrate can be made by a number of conventional techniques widely used in the paper, plastic film industry etc

According to one embodiment, the production of pollutant decomposition devices according to the present invention is performed in an essentially continuous manner, wherein the flexible sheet substrate is provided in the form of a coil, and the deposition and slitting are performed in a continuous production line.

According to one embodiment of the pollutant decomposition device the spacer means are comprised of ridges that are formed by a plurality of partially plastic folds. The “folded” decomposition may further comprise perforations or slits to enhance the flow of water from the front side to the back side of the sheet substrate. In order to fit this embodiment into a bottle etc, with a narrow opening, the device is compressed to a compact state. Thereafter, when the device has entered the wider cavity in the bottle, the flexible nature of the sheet material expands the device so that it essentially follows the inner wall of the bottle. The embodiment well suited to be retained in the compact state by an adhesive as discussed above.

According to one embodiment, the sheet substrate is comprised of a flexible material such as a plastic film or the like. In this case it is possible to make the device self-expanding, by controlling the folding and/or rolling process so that it at least partially involves elastic deformation of the sheet substrate. The resulting device will therefore self-expand to the expanded state by the spring force stored by the elastic deformation of the sheet substrate. By carefully designing the folding/rolling process, the resulting device may exhibit a very large expansion factor.

The pollutant decomposition device according to the present invention can be arranged in a container defining a purifying chamber in order to form an effective water purifying device.

According to one embodiment, the pollutant decomposition device is arranged inside a transparent container thereby forming an effective and low cost water purifying system that can be used basically anywhere. As discussed above, there is a tremendous need for such water purifying systems throughout the world. As discussed above, the photocatalytic action results in decomposition of the vast majority of occurring biological and organic pollutants (as well as some inorganics) in drinking water. In order to activate the photocatalytic surface, the container at least in part is transparent to electromagnetic radiation that activates the photocatalytic surface. According to one embodiment, the container is a transparent bottle, made of glass or a plastic material, e.g. a PET-bottle.

According to one embodiment, the pollutant decomposition device is arranged to be inserted inside containers available at the site, where purified water is needed, such as empty PET—bottles etc. Hence, the compact state permits insertion of the device through an opening in the transparent container, the opening having a cross sectional area that is smaller that the cross sectional area of a cavity inside the container with respect to the direction of insertion, and the expanded state retains the device inside the container. In this way, an extremely simple and reliable water purifying system is achieved

Hence, in order to achieve maximum capacity, the pollutant decomposition device should be designed so that the resulting irradiated area is made as large as possible. However, it is also of great importance that the pollutant decomposition device is designed so that the whole volume of water is purified. Basically, this means that the design should be such that no protected “pockets” are created in the system, wherein polluted water is trapped and thus not purified.

One major advantage with the present invention as disclosed in the FIGS. 2 to 4 is that the pollutant decomposition devices occupies an extremely small space during transport, and therefore can be transported in large quantities to essentially any site, remote or not.

According to one embodiment there is provided a water purifying device wherein the container is a collapsible container and wherein the pollutant decomposition device is permanently arranged in the container. Preferably, the pollutant decomposition device is arranged to be expanded simultaneously with expansion of the container, which can be achieved in that the expansion of the pollutant decomposition device is forced by the expansion of the collapsible container. In one embodiment, this can be achieved in that the spacer means of the pollutant decomposition device are attached to the inner wall of the collapsible container and expanded by the expansion of the container. Such ready-to-use collapsible water purifying devices can readily be used where transparent containers are not available in sufficient amount, e.g. massive rescue situations after natural disasters etc, there might not be enough transparent bottles available, etc.

According to one embodiment the pollutant decomposition device is arranged in a container in the form of a hose, i.e. an elongated container with two openings, of normal type or of inflatable type.

According to one embodiment of the present invention, purified water is achieved by a method comprising the steps:

placing a pollutant decomposition device according to claim 1 inside a transparent container,
filling the container with water to be purified, and
illuminating the container for a period of time.

The decomposition capacity of the system depends on a number of parameters, such as:

the irradiated area of the photocatalytic surface,
the irradiation intensity
the chemical stability of the pollutant to be decomposed
the temperature of the system.

In order to indicate the real decomposition state/rate there is provided a purification indicator. The indicator is a water-soluble non-toxic colored substance arranged to indicate the purification level of water in a photocatalytic purification process. A predetermined dose of the colored substance is added to the water to be purified, and the colored substance is selected so that it is decomposed by the photocatalytic purification process.

In order for the indicator to give a correct indication of the decomposition process the dose is selected with respect to the pollutant(s) present in the water to be purified, its concentration, and its decomposition rate in the photocatalytic purification process. The decomposition of the colored substance results in decomposition into non-toxic substances that are differently colored or not colored.

When using the purification indicator, the above method of purifying water comprises the steps:

dissolving a purification indicator in the water to be purified, and
terminating the purification when the indicator indicates that the purification process is completed.

1. Pollutant decomposition device comprising a flexible sheet-substrate provided with at least one photocatalytic surface wherein
the sheet-substrate comprises one or more internal slits with a layout that provides formation of flow restricting means upon predetermined deformation of the sheet substrate.

2. Pollutant decomposition device according to claim 1, wherein the predetermined deformation of the sheet substrate comprises folding, stretching, coiling or twisting, or a combination thereof.

3. Pollutant decomposition device according to claim 1, wherein the predetermined deformation is essentially elastic.

4. Pollutant decomposition device according to claim 1, wherein the predetermined deformation is at least partially plastic.

5. Pollutant decomposition device according to claim 1, wherein the sheet substrate is a plastic film or metal foil.

6. Pollutant decomposition device according to claim 1, wherein the slits are generally V or U shaped, forming flow restricting means in the form of V or U shaped tongues.

7. Pollutant decomposition device according to claim 6, wherein the slit layout comprises parallel rows of V or U shaped slits.

8. Pollutant decomposition device according to claim 7, wherein adjacent rows of slits are offset by the half center to center distance between two slits, and arranged upside-down.

9. Pollutant decomposition device according to claim 1, comprising edge slits.

10. Pollutant decomposition device according to claim 1, comprising perforations.

11. Pollutant decomposition device according to claim 1 wherein the flow restricting means are formed to provide a small contact area between the pollutant decomposition device and an adjacent surface.

12. Pollutant decomposition device according to claim 1, wherein it comprises at least one interlock tongue arranged to fit into a mating interlock slit in order to interlock the deformed sheet substrate in the deformed state.

13. Use of a pollutant decomposition device according to claim 1 in a flow through medium cleaner.

14. Flow through medium cleaner comprising at least one flow channel, and at least one pollutant decomposition device according to claim 1 arranged in the flow channel.

15. Method of producing a pollutant decomposition device, comprising the steps:
providing a flexible sheet substrate,
depositing a photocatalytic layer on a surface of the sheet substrate,
slitting the sheet substrate to form one or more internal slits with a layout that provides formation of flow restricting means upon predetermined deformation of the sheet substrate, and
deforming the sheet substrate in a predetermined manner.
